(19) United States
(12) Patent Application Publication
(10) Pub. No.: US 2015/0193980 A1
(43) Pub. Date: Jul. 9, 2015

(54) CALIBRATION OF AUGMENTED REALITY (AR) OPTICAL SEE-THROUGH DISPLAY USING SHAPE-BASED ALIGNMENT

(71) Applicant: QUALCOMM Incorporated, San Diego, CA (US)

(72) Inventors: Christopher PEDLEY, Cambridge (GB); Jonathan David WARD, Cambridge (GB); Arpit MITTAL, Cambridge (GB); Giuliano MACIOCCI, Cambridge (GB)

(73) Assignee: QUALCOMM Incorporated, San Diego, CA (US)

(21) Appl. No.: 14/225,042

(22) Filed: Mar. 25, 2014

Related U.S. Application Data
(60) Provisional application No. 61/924,132, filed on Jan. 6, 2014.

(51) Int. Cl. G06T 19/00; G06F 3/0346; G06T 7/00; G02B 27/01

(52) U.S. Cl. CPC G06T 19/006; G02B 27/017; G06F 3/0346; G06T 7/0024; G02B 2027/014; G02B 2027/0138; G02B 2027/0187; G02B 27/0093

(57) ABSTRACT

Two-dimensional or three-dimensional augmented reality (AR) markers are provided for alignment with a target object in calibrating an optical see-through display, such as a head-mounted display (HMD), in an AR system. A calibrated projection matrix for calibration of the optical see-through display is computed based upon a user's repeated alignments of the AR markers with the target object.

### CROSS-REFERENCE TO RELATED APPLICATIONS

The present Application for Patent claims the benefit of U.S. Provisional Application No. 61/924,132, entitled “CALIBRATION OF AUGMENTED REALITY (AR) OPTICAL SEE-THROUGH DISPLAY USING SHAPE-BASED ALIGNMENT,” filed Jan. 6, 2014, assigned to the assignee hereof, and expressly incorporated herein by reference in its entirety.

### FIELD OF DISCLOSURE

Various embodiments described herein relate to calibration of optical systems, and more particularly, to calibration of optical see-through displays.

### BACKGROUND

Augmented reality (AR) is a live, direct or indirect, view of a physical, real-world environment in which one or more objects or elements are augmented or supplemented by computer-generated sensory input such as sound, video, graphics or GPS data. As a result, a typical AR system is designed to enhance, rather than to replace, one's current perception of reality. Various types of AR systems have been devised for game, entertainment, and other applications involving video. In a typical AR video system, for example, a user is typically able to see a real stationary or moving object, but the user's visual perception of the real object may be augmented or enhanced by a computer or machine generated image of that object.

Two different types of display, namely, video see-through and optical see-through, are used to enhance the user's visual perception of real objects in existing AR systems. In a typical video see-through system, the user sees a live video of a real-world scenario, including one or more particular objects augmented or enhanced on the live video. This type of video see-through system is suitable for various applications, such as video on a phone display. Visual augmentation in video see-through AR systems may be performed by software platforms such as Qualcomm® Vuforia™, a product of Qualcomm Technologies, Inc. and its subsidiaries, for example.

In an optical see-through system with AR features, the user sees objects augmented directly onto the real-world view without a video. In a typical optical see-through system, the user may view physical objects through one or more screens, glasses or lenses, for example, and computer-enhanced graphics may be projected onto the screens, glasses or lenses to allow the user to obtain enhanced visual perception of one or more physical objects. One type of display used in an optical see-through AR system is a head-mounted display (HMD) having a glass in front of each eye to allow the user to see an object directly, while also allowing an enhanced image of that object to be projected onto the glass to augment the visual perception of that object by the user.

A typical optical see-through display such as an HMD with AR features may need to be calibrated for a user such that a computer-enhanced image of an object projected on the display is aligned properly with that object as seen by the user. Conventional schemes have been devised for calibrating HMDs in optical see-through AR systems, but they typically require the user to perform multiple calibration steps manually.

### SUMMARY

Exemplary embodiments of the invention are directed to apparatus and method for calibration of optical see-through systems. At least some embodiments of the invention are applicable to apparatus and method for calibration of optical see-through head-mounted display (HMD) in augmented reality (AR) systems.

In an embodiment, a method of calibrating an optical see-through display comprises the steps of: (a) repeating the steps of (i) receiving an input from a user indicating that the user has aligned an augmented reality (AR) marker with an object on the optical see-through display; and (ii) obtaining a pose matrix based upon the user's alignment of the AR marker with the object; and (b) computing a calibrated projection matrix for calibration of the optical see-through display based upon a plurality of pose matrices.

In another embodiment, an apparatus configured to perform operations to calibrate an optical see-through display is provided, the apparatus comprising: a memory; and a processor for executing a set of instructions stored in the memory, the set of instructions for: (a) repeating the steps of: (i) receiving an input from a user indicating that the user has aligned an augmented reality (AR) marker with an object on the optical see-through display; and (ii) obtaining a pose matrix based upon the user's alignment of the AR marker with the object; and (b) computing a calibrated projection matrix for calibration of the optical see-through display based upon a plurality of pose matrices.

In another embodiment, an apparatus configured to perform operations to calibrate an optical see-through display is provided, the apparatus comprising: (a) means for repeating the steps of: (i) receiving an input from a user indicating that the user has aligned an augmented reality (AR) marker with an object on the optical see-through display; and (ii) obtaining a pose matrix based upon the user's alignment of the AR marker with the object; and (b) means for computing a calibrated projection matrix for calibration of the optical see-through display based upon a plurality of pose matrices.

In another embodiment, a machine-readable storage medium encoded with instructions executable to perform operations to calibrate an optical see-through display is provided, the operations comprising: (a) repeating the steps of: (i) receiving an input from a user indicating that the user has aligned an augmented reality (AR) marker with an object on the optical see-through display; and (ii) obtaining a pose matrix based upon the user's alignment of the AR marker with the object; and (b) computing a calibrated projection matrix for calibration of the optical see-through display based upon a plurality of pose matrices.

Some exemplary embodiments of the invention are described below in the Detailed Description and illustrated by the drawings. The invention, however, is defined by the claims and is not limited by the exemplary embodiments described and illustrated.

### BRIEF DESCRIPTION OF THE DRAWINGS

The accompanying drawings are presented to aid in the description of embodiments of the invention and are provided solely for illustration of the embodiments and not limitation thereof.

FIG. 1 is a simplified side view of an embodiment of an augmented reality (AR) optical see-through head-mounted display (HMD) worn by a human user;

FIG. 2 is a simplified side view of another embodiment of an AR optical see-through HMD worn by a human user;

FIG. 3A is a top view of an AR calibration system showing the placement of an HMD-mounted camera between two eyes of the user;

FIG. 3B is a side view of the AR calibration system of FIG. 2, showing the placement of the HMD-mounted camera above each eye;

FIG. 4 is a perspective view illustrating the use of a two-dimensional rectangular AR marker for calibrating the HMD;

FIG. 5A is a perspective view illustrating a three-dimensional AR marker in the shape of a truncated rectangular pyramid;

FIG. 5B is a top view of the truncated rectangular pyramid of FIG. 5A;

FIG. 6 is a flowchart illustrating an embodiment of a method of calibration; and

FIG. 7 is a flowchart illustrating another embodiment of a method of calibration.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the,” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise.

Furthermore, many embodiments are described in terms of sequences of actions to be performed by, for example, elements of a computing device. It will be recognized that various actions described herein can be performed by specific circuits, such as application specific integrated circuits (ASICs), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

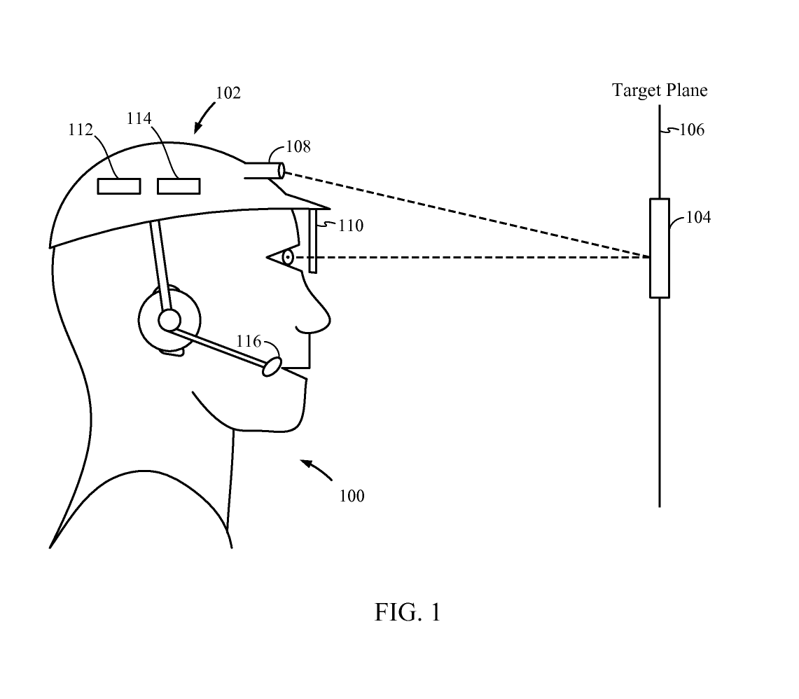

FIG. 1 illustrates a simplified side view of a human user 100 wearing a head-mounted display (HMD) 102 as an optical see-through device which allows the user 100 to view an object 104 on a target plane 106 at a distance from the user 100. The HMD 102 has a camera 108 and a glass or screen 110 on which an enhanced or augmented image may be projected or otherwise displayed to allow the user 100 to obtain an augmented visual perception of the object 104. Various types of optical see-through devices including various types of HMDs have been developed with augmented reality (AR) features. Before the user 100 can effectively use the HMD 102 with AR features, calibration of the HMD 102 typically need be performed to ensure that the enhanced or augmented image is aligned properly with the real object as seen by the user 100 through the glass or screen 110. The apparatus and methods according to various embodiments disclosed herein may be implemented for calibration of such HMDs with AR features with relatively few easy steps to be performed by the user.

As illustrated in FIG. 1, for example, a machine-readable storage medium such as a memory 112 as well as a processor 114 may be provided in the HMD 102 for storing and executing instructions to perform process steps for calibration of the HMD 102 based upon images obtained by the camera 108. The types of optical see-through displays to be calibrated are not limited to HMDs, however. The apparatus and methods of calibration according to embodiments disclosed herein may be applicable to various types of optical see-through displays, such as a glass frame, for example, with a camera 108 or optical sensor mounted on or near the glass frame. In the embodiment shown in FIG. 1, the memory 112 and the processor 114 are integrated as part of the HMD 102. In addition, a microphone 116 may be provided on the HMD 102 to receive voice input from the user 100 indicating that alignment has been achieved. Alternatively, the user 100 may indicate that alignment has been achieved by various other means of input, such as by pressing a button, a key on a keyboard or keypad, or a soft key on a touch screen, for example.

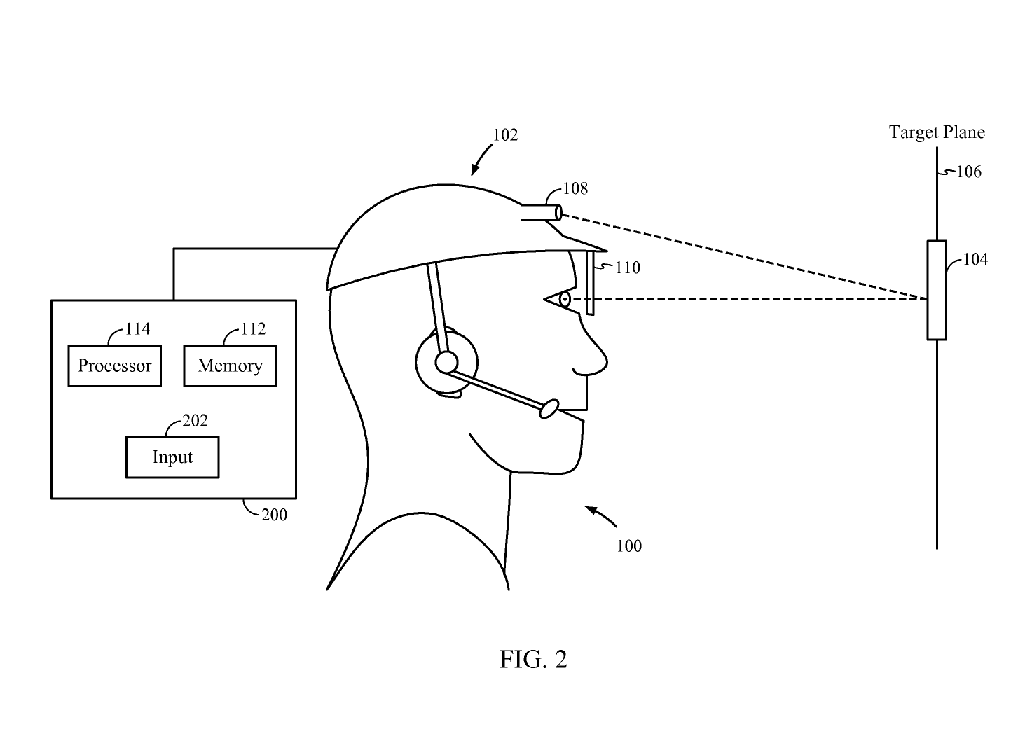

FIG. 2 illustrates a simplified side view similar to FIG. 1, except that the memory 112 and the processor 114 are implemented in a device 200 separate from the HMD 102. In an embodiment, the connection between the device 200 and the HMD 102 is a wired connection. Alternatively, the connection between the device 200 and the HMD 102 is a wireless connection. The device 200 housing the memory 112 and the processor 114 may be a computer, a mobile phone, a tablet, or a game console, for example. In an embodiment, the user 100 may provide input 202 to the processor 114 and memory 112 by pressing a button or key, or by tapping a soft key on a touch screen on the device 200, or by various other means, such as a voice command, for example.

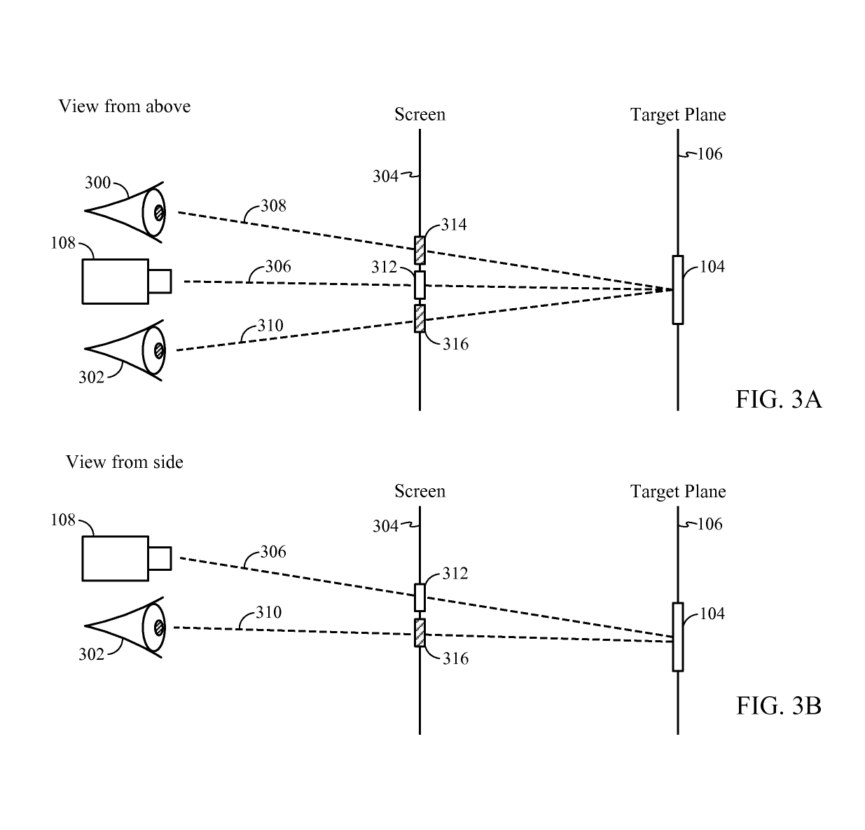

FIGS. 3A and 3B are simplified top and side views, respectively, of an example of a setup for performing calibration for an HMD. For simplicity of illustration, only the camera 108 and eyes 300 and 302 of the user are shown in FIGS. 3A and 3B, without also showing other parts of the HMD 102 as illustrated in FIGS. 1 and 2. It is understood that optical see-through displays of various designs, shapes and sizes may be implemented without departing from the scope of the invention. In the top view of FIG. 3A, the camera 108 is positioned between the left eye 300 and the right eye 302, although the camera 108 need not be perfectly centered between the two eyes 300 and 302. In the side view of FIG. 3B, the camera 108 is positioned above the right eye 302 and the left eye 300 (not shown).

In an embodiment, when looking through an optical see-through display or HMD, the user typically sees an imaginary or floating screen 304, which is typically about an arm's length away from the user. Because the camera 108 is spaced apart horizontally from each of the eyes 300 and 302 as shown in FIG. 3A, the line of sight 306 of the camera 108 is different from lines of sight 308 and 310 of the left and right eyes 300 and 302, respectively, in the horizontal plane. Likewise, because the camera 108 is also spaced apart vertically from the eye 302 as shown in FIG. 3B, the line of sight 306 of the camera 108 is different from the line of sight 310 in the vertical plane. As a consequence, object 104 is seen by the camera 108 on the floating screen 304 at a position 312 which is different from both the position 314 on the floating screen 304 as seen by the left eye 300, and the position 316 on the floating screen 304 as seen by the right eye 302.

In the top view of FIG. 3A, the position 312 of the object 104 on the floating screen 304 as seen by the camera 108 is spaced apart horizontally from the positions 314 and 316 of the object 104 on the floating screen 304 as seen by the left and right eyes 300 and 302, respectively. Similarly, in the side view of FIG. 3B, the position 312 of the object 104 on the floating screen 304 as seen by the camera 108 is spaced apart vertically from the position 316 of the object 104 on the floating screen 304 as seen by the eye 302. In order to compensate for the fact that the camera 108 has a line of sight 306 to the object 104 different from lines of sight 308 and 310 of the left and right eyes 300 and 302, both horizontally and vertically, methods are provided herein for calibration of the camera 108 using AR markers to allow enhanced or augmented images of objects to be aligned with corresponding real objects as seen by the user on the optical see-through display.

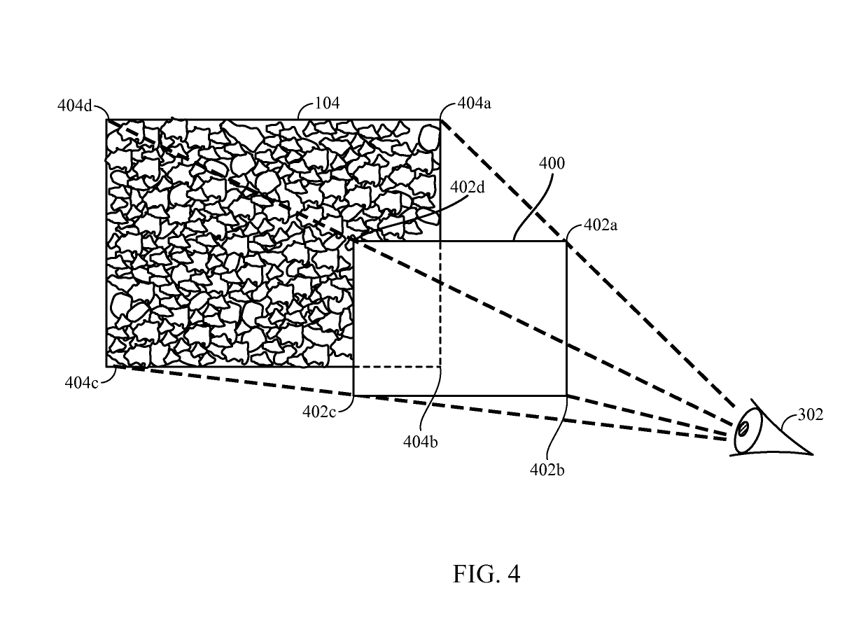

FIG. 4 is a simplified perspective view illustrating an embodiment using a two-dimensional AR marker, such as a rectangular AR marker 400, for calibrating an optical see-through display such as an HMD as shown in FIGS. 1 and 2. In the example shown in FIG. 4, the rectangular AR marker 400 is seen by the user as if it is projected onto a floating screen, and the target object 104 chosen for alignment is also a rectangle. In an embodiment, the rectangular AR marker 400 may be drawn by a computer using a conventional application program, such as OpenGL. In another embodiment, the AR marker 400 may be a physical marker of a predefined shape for alignment with a target object 104 of the same shape. The target object 104 may be a real object or an image projected on a wall or a screen at a distance from the eye 302 of the user greater than the distance between the eye 302 of the user and the HMD. In an embodiment, the target object 104 comprises a rectangularly bordered image of stones as shown in FIG. 4.

In the embodiment shown in FIG. 4, a user wearing an HMD (not shown) lines up the rectangular AR marker 400 with the rectangular target object 104 by aligning the four corners 402a, 402b, 402c and 402d of the rectangular AR marker 400 with the four corners 404a, 404b, 404c and 404d of the rectangular target object 104, respectively, as seen by the eye 302 of the user. The dimension of the rectangular AR marker 400 may be chosen such that it occupies at least an appreciable portion of the field of view of the eye 302 of the user as seen through the HMD. In an embodiment, the user wearing the HMD may align the corners of the rectangular AR marker 400 with those of the target object 104 by moving his or her head until the four corners of the rectangular AR marker 400 coincide with respective corners of the target object 104 as viewed by his or eye 302 through the HMD, for example. Alternatively, the user may align the corners of the rectangular AR marker 400 with those of the target object 104 by adjusting the angles or distance of the HMD he or she is wearing with respect to his or her eyes, for example. Once the corners of the rectangular AR marker and those of the target object are respectively aligned, the user may indicate to the processor that alignment has been achieved by tapping the screen, for example, or by other means of user input indicating that the user has achieved alignment between the AR marker and the target object, such as by pressing a key on a computer keyboard, a keypad, a soft key on a touch screen, a button, or by voice recognition, for example.

In an embodiment, the same procedure may be repeated for alignment of rectangular AR markers drawn at slightly different locations. Furthermore, repeated alignments of rectangular AR markers drawn at slightly different locations are performed separately for each eye. Although the embodiment shown in FIG. 4 illustrates the use of a rectangular AR marker and a rectangular target object, AR markers and target objects of other shapes may also be used within the scope of the invention. For example, a polygonal AR marker may be used to allow the user to align the marker with a polygonal target object of the same shape with proportional dimensions. Planar surfaces of other shapes such as circles, ellipses, surfaces with curved edges, or surfaces with a combination of curved and straight edges may also be used as AR markers, as long as the user is able to align such shapes with correspondingly shaped target objects seen by the user through the optical see-through display.

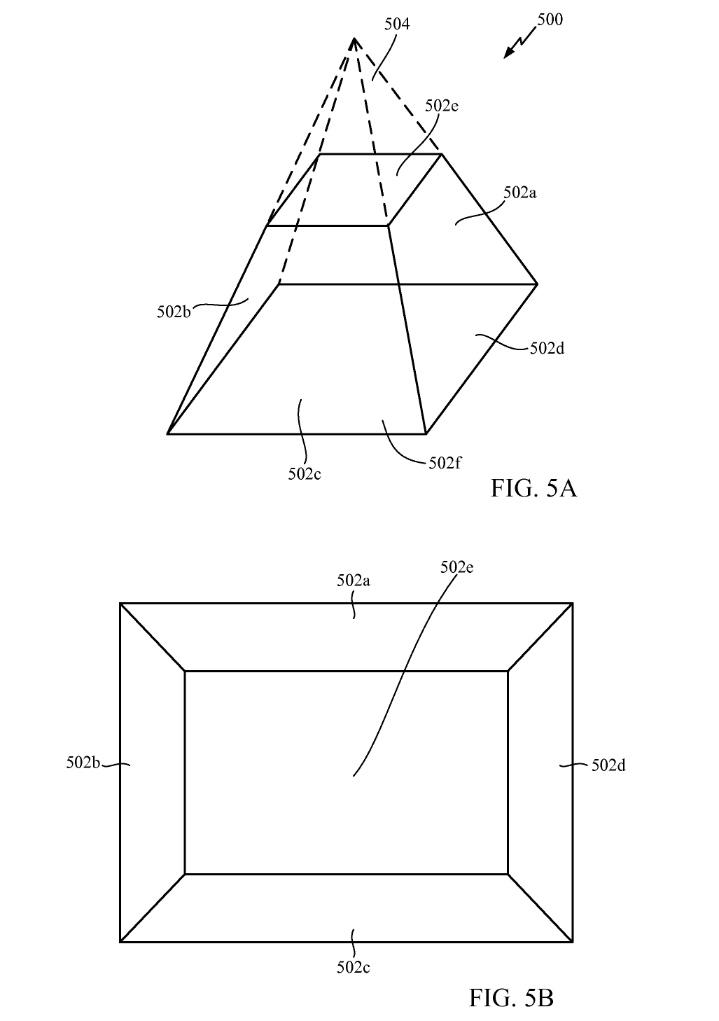

In addition to two-dimensional AR markers, three-dimensional markers may also be used within the scope of the invention. For example, in an embodiment in which a three-dimensional marker has multiple polygonal surfaces, each surface of the three-dimensional marker may serve as a separate two-dimensional AR marker for the user to align with a given target object. FIG. 5A shows a perspective view of a truncated rectangular pyramid 500, which is just one of many examples of three-dimensional markers that may be used for calibration of optical see-through displays. In FIG. 5A, the truncated rectangular pyramid 500 has four trapezoidal surfaces, 502a, 502b, 502c and 502d, a rectangular surface 502e resulting from truncation of the top portion 504 of the rectangular pyramid 500, and a base 502f, which is a rectangle. In an embodiment, five surfaces of the truncated rectangular pyramid 500, namely, the four trapezoidal surfaces 502a, 502b, 502c, 502d and 502e, and the rectangular surface 502e, are used as AR markers. FIG. 5B shows a top plan view of the surfaces 502a, 502b, 502c, 502d and 502e taken from the truncated rectangular pyramid of FIG. 5A and chosen as AR markers. The rectangular base 502f of the pyramid 500 is not used as an AR marker in the embodiment shown in FIGS. 5A and 5B because it is parallel to and has the same shape as the rectangular surface 502e. However, the base 502f may be used as an AR marker in other embodiments, along with other surfaces taken from the three-dimensional AR marker.

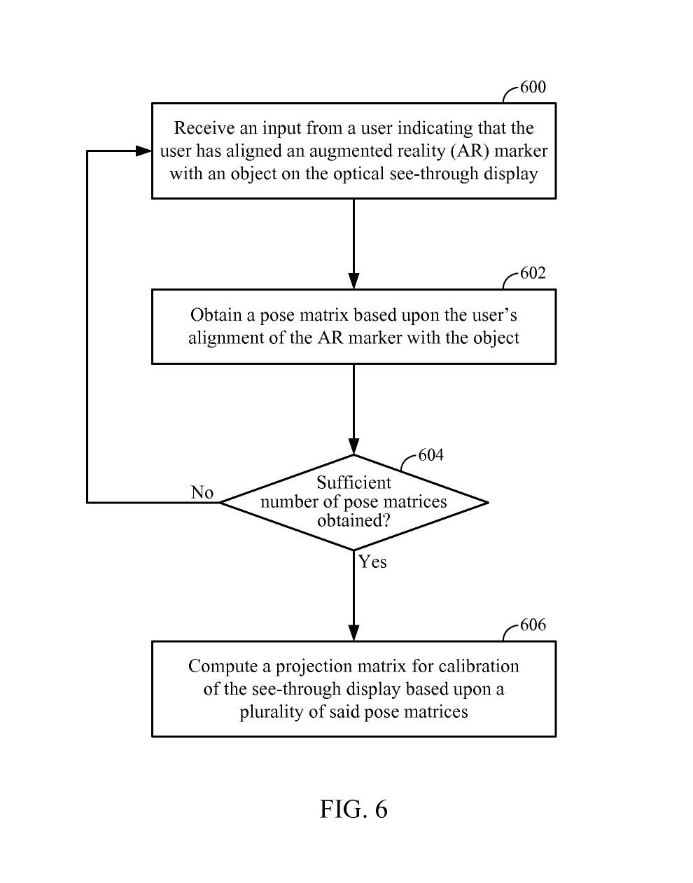

FIG. 6 shows a simplified flowchart illustrating a method of calibrating an optical see-through display according to an embodiment of the invention. In step 600, a computer that includes a memory 112 and a processor 114, which can be either integrated in the HMD 102 as shown in FIG. 1 or a separate device 200 as shown in FIG. 2, receives an input from a user indicating that the user has aligned an augmented reality (AR) marker with an object on the optical see-through display. In one embodiment, a computer receives an input indicating that the user has aligned an AR marker seen by the user on the optical see-through display with an object (such as a physical object and/or an image displayed or projected on a screen) the user sees through the optical see-through display. As described above, the user input may be received through various means, such as a button, a key on a keyboard or a keypad, a soft key on a touch screen, or a microphone with voice recognition, for example, to indicate to the processor that the user has aligned an AR marker with a designated target object on an optical see-through display, such as the HMD as shown in FIGS. 1 and 2. Referring to FIG. 6, after the computer receives user input indicating that the user has aligned the AR marker with the designated target object on the optical see-through display, the computer obtains a pose matrix based upon the user's alignment of the AR marker with the target object in step 602 in a conventional manner.

In an embodiment, steps 600 and 602 in FIG. 6 are repeated until the computer determines that a sufficient number of pose matrices have been obtained in step 604. In the example illustrated in FIG. 4 and described above, a two-dimensional rectangular AR marker may be redrawn at a new location slightly different from its previous location in each iteration of steps 600 and 602. The user needs to align the AR marker at each given location with the target object and notifies the computer that the user has aligned the AR marker at that location with the target object in each iteration. The computer obtains a pose matrix based on the user's alignment of the AR marker at the given location with the target object in each iteration of step 602. In an embodiment, a predetermined number of iterations may be programmed into the computer, and the location of the AR marker for each iteration may also be preprogrammed into the computer, for example. In another embodiment, the number of pose matrices required to compute a projection matrix may be dynamically determined based on whether sufficiently good data has been obtained for computing a calibrated projection matrix based on the pose matrices obtained by repeated alignments of the AR marker with the target object as seen by the user. Referring to FIG. 6, upon determining that a sufficient number of pose matrices have been obtained in step 604, the computer computes a projection matrix for the calibration of the optical see-through display based on a plurality of pose matrices in step 606.

In an embodiment, an algorithm is provided for computing the calibrated projection matrix in the case of two-dimensional AR markers. Such a calibrated projection matrix may be registered in the computer for correcting any misalignment of lines of sight of the eyes 300 and 302 of the user with the line of sight of the camera 108 as illustrated in FIGS. 3A and 3B, such that an enhanced or augmented image of a real object generated by the computer and projected on the optical see-through display can be aligned with that real object as seen by the user. It is understood that the algorithm described herein is only one of many embodiments of computing calibrated projection matrices for alignment within the scope of the invention.

An exemplary equation for computing a projection matrix before viewpoint transformation is as follows:

PMV=C

where
P=projection matrix
M=model-view matrix
V=three-dimensional vertices of the rectangle to be drawn
C=screen coordinates of rectangle

In the embodiment of alignment using a two-dimension rectangular AR marker as illustrated in FIG. 4 and described above, initial values of M and V are supplied to draw the rectangle. The actual value of the projection matrix P is unknown at this point, but an initial estimate for P may be supplied, and the value of P may be updated in each step of calibration. During each calibration step the same rectangle with three-dimensional vertices V is drawn but with a different matrix M. The screen coordinates of the rectangle C can then be calculated by multiplying P, M and V and saved in the memory of the computer. Each time the user provides an input to the computer indicating that alignment of the rectangular AR marker with the rectangular target object has been achieved, by pressing a button, a keyboard or keypad key, a soft key on a screen, or by a voice command through a microphone, for example, a pose matrix reading is generated by the computer in a conventional manner.

To calculate the projection matrix needed for calibration of an optical see-through display or an HMD, for example, the same values for V and C may be used to draw the original rectangle, but the value for M may be replaced with a pose matrix generated by the computer. A plurality of pose matrices are generated based on repeated iterations of placing the rectangular AR marker at slightly different locations and receiving input from the user indicating that the AR marker has been aligned with the target object in each iteration. A new projection matrix P′ for calibration can be computed from multiple readings of pose matrices M.

Because there are multiple readings of pose matrices M based on multiple iterations of user's alignment of the AR marker at slightly different locations, the projection matrix P may not be solved independently for each reading of the pose matrix M during each iteration. In an embodiment, the pose matrix M may be multiplied by V for each reading and the results are then concatenated to obtain a concatenated product matrix N. Assuming that four iterations of alignment are performed by the user, four readings Mₐ, M_{b}, M_{c}, M_{d} of pose matrices are obtained. The concatenated product matrix N may be computed as follows:

N=MₐV∥M_{b}V∥M_{c}V∥M_{d}V

The screen coordinate matrices are concatenated to generate a concatenated screen coordinate matrix C as follows:

C=Cₐ∥C_{b}∥C_{c}∥C_{d}

The relationship between the projection matrix P′, the concatenated product matrix N and the concatenated screen coordinate matrix C is:

P′N=C

P′ can then be solved by using the pseudo-inverse of the concatenated product matrix N, that is, N⁺:

P′=CN⁺

Because the pseudo-inverse of a matrix is computed only once, and the other linear algebra computations are relatively simple, there may not be a need for a great amount of computing resources for calibration in this embodiment. Furthermore, the user need not enter any data other than a simple indication that the AR marker has been aligned with the target object in each iteration, thereby obviating the need for a complicated manual calibration process for optical see-through displays.

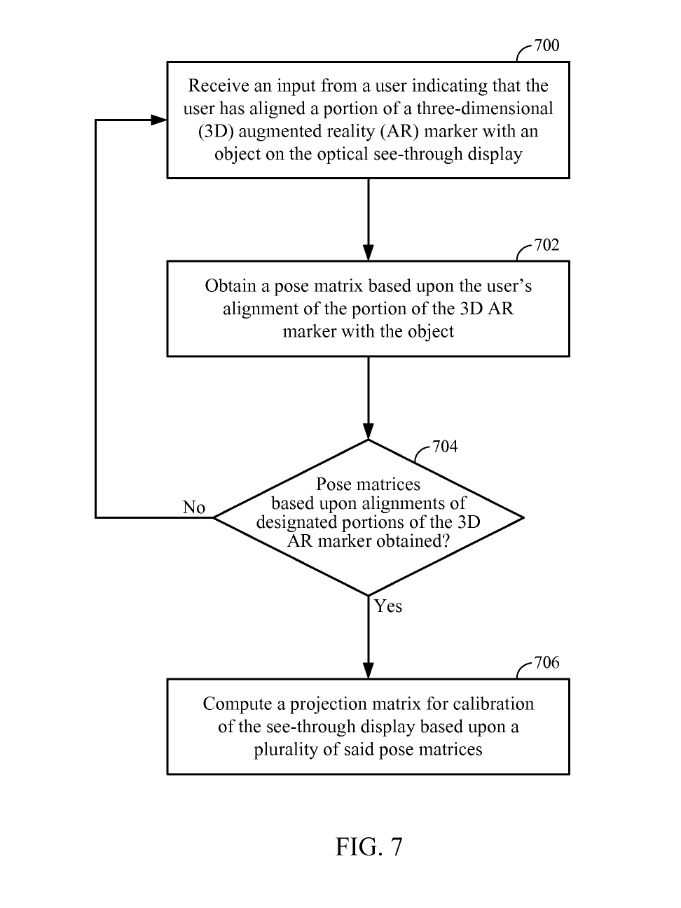

FIG. 7 shows a simplified flowchart illustrating a method of calibrating an optical see-through display according to another embodiment of the invention using a three-dimensional (3D) AR marker. In step 700, a computer that includes a memory 112 and a processor 114, which can be either integrated in the HMD 102 as shown in FIG. 1 or a separate device 200 as shown in FIG. 2, received an input from a user indicating that the user has aligned a portion, for example, a designated surface, of a 3D AR marker with an object on the optical see-through display. As described above, the user input may be received through various means, such as a button, a key on a keyboard or a keypad, a soft key on a touch screen, or a microphone with voice recognition, for example, to indicate to the processor that the user has aligned that portion of the 3D AR marker with a target object on an optical see-through display, such as the HMD 102 as shown in FIGS. 1 and 2. After the computer receives user input indicating that the user has aligned the designated portion of the 3D AR marker with the target object on the optical see-through display, the computer obtains a pose matrix based upon the user's alignment of the designated portion of the 3D AR marker with the target object in step 702.

In an embodiment, steps 700 and 702 in FIG. 7 are repeated until the computer determines that a sufficient number of pose matrices have been obtained in step 704. In the embodiment in which a 3D AR marker in the shape of a truncated rectangular pyramid 500 as illustrated in FIGS. 5A and 5B and described above is implemented, for example, the trapezoidal surfaces 502a, 502b, 502c and 502d and the rectangular surface 502e resulting from truncation are each used as a separate two-dimensional (2D) marker, whereas the base 502f of the pyramid 500 is not used as a marker. In an embodiment, the user performs alignment of each 2D marker with the target object separately. Referring to FIG. 7, steps 700 and 702 are repeated until the computer determines that pose matrices based upon alignments of all designated portions of the 3D AR marker have been obtained in step 704. For example, in the embodiment of FIGS. 5A and 5B in which five surfaces of a truncated rectangular pyramid are used as AR markers, steps 700 and 702 in FIG. 7 may be repeated five times for each eye.

In another embodiment, the user needs to align only one 2D marker which is a portion of the 3D AR marker. For example, in an embodiment in which a truncated rectangular pyramid as illustrated in FIGS. 5A and 5B is used as a 3D AR marker, the user may only need to align the rectangular surface 502e of the 3D AR marker and the computer may perform computations to generate pose matrices based on the known vertices of the other surfaces 502a, 502b, 502c and 502d of the 3D AR marker. Upon determining that a sufficient number of pose matrices have been obtained, the computer computes a projection matrix for the calibration of the optical see-through display based on a plurality of pose matrices in step 706.

In an embodiment, an algorithm generally similar to the one described above based on the use of two-dimensional rectangular AR markers may be implemented for the case of a 3D AR marker with multiple 2D surfaces. It is understood, however, that various computational schemes may be devised within the scope of the invention for computing calibrated projection matrices for optical see-through displays based on the use of 3D markers.

In an embodiment, a typical equation for 3D rendering is as follows:

PMV=C

where
P=projection matrix
M=model-view matrix
V=3D vertices of the object to be drawn
C=2D screen coordinates

In an embodiment, the computer builds a 3D model representing the 3D AR marker. In the example of the 3D AR marker in the shape of a truncated rectangular pyramid 500 as shown in FIGS. 5A and 5B, five designated surfaces 502a, 502b, 502c, 502d and 502e serve as 2D AR markers. The sets of vertices that describe the five designated surfaces of the 3D model are Vₐ, V_{b}, V_{c}, V_{d} and Vₑ, respectively. Among the five designated surfaces, surface 502e is a rectangular surface with vertices Vₑ. The rectangle that the user 100 needs to align with is drawn by using an initial estimated projection matrix P, the model-view matrix M and the set of vertices Vₑ. In an embodiment, only one set of vertices Vₑ is actually drawn, whereas the screen coordinates for other sets of vertices Vₐ, V_{b}, V_{c} and V_{d} may be calculated, because the computer has built an internal 3D model and knows the coordinates of the other sets of vertices.

The screen coordinates of surface 502a can be computed as follows:

Cₐ=PMVₐ

The screen coordinates of other surfaces of the 3D marker may be computed in a similar manner:

C_{b}=PMV_{b}

C_{c}=PMV_{c}

C_{d}=PMV_{d}

Cₑ=PMVₑ

All the screen coordinates are then concatenated to a larger concatenated screen coordinate matrix C as follows:

C=Cₐ∥C_{b}∥C_{c}∥C_{d}∥Cₑ

In an embodiment in which a 3D marker is used for calibration, a pose matrix may be read for each of the 2D markers that make up the 3D marker, and multiple pose matrices Mₐ, M_{b}, ^{M}_{c}, M_{d} and Mₑ may be returned simultaneously. Alternatively, the pose matrices Mₐ, M_{b}, ^{M}_{c}, M_{d} and Mₑ may be returned sequentially or in any order within the scope of the invention. These pose matrices can then be used to calculate a concatenated product matrix N:

N=MₐVₐ∥M_{b}V_{b}∥M_{c}V_{c}∥M_{d}V_{d}∥MₑVₑ

The new calibrated projection matrix P′ can then be found by solving the equation:

P′N=C

Various algorithms may be implemented to solve the calibration projection matrix P in this equation. In an embodiment, P′ can be solved by multiplying C by the pseudo-inverse of N, that is, N⁺, which is calculated through singular value decomposition:

P′=CN⁺

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The methods, sequences or algorithms described in connection with the embodiments disclosed herein may be embodied directly in hardware, in a software module executed by a processor, or in a combination of the two. A software module may reside in RAM, flash memory, ROM, EPROM, EEPROM, registers, a hard disk, a removable disk, a CD-ROM, or any other form of storage medium known in the art. An exemplary storage medium is coupled to the processor such that the processor can read information from, and write information to, the storage medium. In an alternative, the storage medium may be integral to the processor.

Accordingly, an embodiment of the invention can include a computer readable medium embodying a method for calibration of optical see-through displays using shaped-based alignment. Accordingly, the invention is not limited to illustrated examples and any means for performing the functionality described herein are included in embodiments of the invention.

While the foregoing disclosure describes illustrative embodiments of the invention, it should be noted that various changes and modifications could be made herein without departing from the scope of the invention as defined by the appended claims. The functions, steps or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of calibrating an optical see-through display, comprising the steps of:
(a) repeating the steps of:
(i) receiving an input from a user indicating that the user has aligned an augmented reality (AR) marker with an object on the optical see-through display; and
(ii) obtaining a pose matrix based upon the user's alignment of the AR marker with the object; and
(b) computing a calibrated projection matrix for calibration of the optical see-through display based upon a plurality of pose matrices.

2. The method of claim 1, wherein the AR marker comprises a two-dimensional marker.

3. The method of claim 2, wherein the two-dimensional marker comprises a rectangular marker.

4. The method of claim 1, wherein the AR marker is formed by at least a portion of a predefined three-dimensional marker.

5. The method of claim 4, wherein the three-dimensional marker comprises a truncated rectangular pyramid having at least five two-dimensional surfaces forming at least five separate AR markers.

6. The method of claim 5, wherein steps (a)(i) through (a)(ii) are repeated at least five times using said at least five separate AR markers.

7. The method of claim 1, wherein step (b) comprises computing screen coordinate matrices by multiplying a projection matrix, a model view matrix and vertices of the object.

8. The method of claim 7, wherein step (b) further comprises computing a concatenated screen coordinate matrix by concatenating said screen coordinate matrices.

9. The method of claim 8, wherein step (b) further comprises:
multiplying each of the pose matrices with the vertices of the object; and
concatenating products of the pose matrices with the vertices of the object to generate a concatenated product matrix.

10. The method of claim 9, wherein the calibrated projection matrix is computed by multiplying the concatenated screen coordinate matrix with an inverse of the concatenated product matrix.

11. An apparatus configured to perform operations to calibrate an optical see-through display, the apparatus comprising:
a memory; and
a processor for executing a set of instructions stored in the memory, the set of instructions for:
(a) repeating n times, n being more than one, and each loop in which steps are repeated is an ith loop, i being less than or equal to n, the steps of:
(i) receiving an input from a user indicating that the user has aligned an augmented reality (AR) marker with an object on the optical see-through display; and
(ii) obtaining an ith pose matrix based upon the user's alignment of the AR marker with the object; and
(b) computing a calibrated projection matrix for calibration of the optical see-through display based upon n pose matrices.

12. The apparatus of claim 11, wherein the AR marker is formed by at least a portion of a predefined three-dimensional marker.

13. The apparatus of claim 12, wherein the three-dimensional marker comprises a truncated rectangular pyramid having at least five two-dimensional surfaces forming at least five separate AR markers.

14. The apparatus of claim 11, wherein step (b) comprises computing screen coordinate matrices by multiplying a projection matrix, a model view matrix and vertices of the object.

15. The apparatus of claim 14, wherein step (b) further comprises computing a concatenated screen coordinate matrix by concatenating said screen coordinate matrices.

16. The apparatus of claim 15, wherein step (b) further comprises:
multiplying each of the pose matrices with the vertices of the object; and
concatenating products of the pose matrices with the vertices of the object to generate a concatenated product matrix.

17. The apparatus of claim 16, wherein the calibrated projection matrix is computed by multiplying the concatenated screen coordinate matrix with an inverse of the concatenated product matrix.

18. An apparatus configured to perform operations to calibrate an optical see-through display, the apparatus comprising:
(a) means for repeating the steps of:
(i) receiving an input from a user indicating that the user has aligned an augmented reality (AR) marker with an object on the optical see-through display; and
(ii) obtaining a pose matrix based upon the user's alignment of the AR marker with the object; and
(b) means for computing a calibrated projection matrix for calibration of the optical see-through display based upon a plurality of said pose matrices.

19. The apparatus of claim 18, wherein the AR marker is formed by at least a portion of a predefined three-dimensional marker.

20. The apparatus of claim 19, wherein the three-dimensional marker comprises a truncated rectangular pyramid having at least five two-dimensional surfaces forming at least five separate AR markers.

21. The apparatus of claim 18, wherein the means for computing the calibrated projection matrix comprises means for computing screen coordinate matrices by multiplying a projection matrix, a model view matrix and vertices of the object.

22. The apparatus of claim 21, wherein the means for computing the calibrated projection matrix further comprises means for computing a concatenated screen coordinate matrix by concatenating said screen coordinate matrices.

23. The apparatus of claim 22, wherein the means for computing the calibrated projection matrix further comprises:
means for multiplying each of the pose matrices with the vertices of the object; and
means for concatenating products of the pose matrices with the vertices of the object to generate a concatenated product matrix.

24. The apparatus of claim 23, wherein the calibrated projection matrix is computed by multiplying the concatenated screen coordinate matrix with an inverse of the concatenated product matrix.

25. A machine-readable storage medium encoded with instructions executable to perform operations to calibrate an optical see-through display, the operations comprising:
(a) repeating the steps of:
(i) receiving an input from a user indicating that the user has aligned an augmented reality (AR) marker with an object on the optical see-through display; and
(ii) obtaining a pose matrix based upon the user's alignment of the AR marker with the object; and
(b) computing a calibrated projection matrix for calibration of the optical see-through display based upon a plurality of said pose matrices.

26. The machine-readable storage medium of claim 25, wherein the AR marker is formed by at least a portion of a predefined three-dimensional marker.

27. The machine-readable storage medium of claim 25, wherein step (b) comprises computing screen coordinate matrices by multiplying a projection matrix, a model view matrix and vertices of the object.

28. The machine-readable storage medium of claim 25, wherein step (b) further comprises computing a concatenated screen coordinate matrix by concatenating said screen coordinate matrices.

29. The machine-readable storage medium of claim 28, wherein step (b) further comprises:
multiplying each of the pose matrices with the vertices of the object; and
concatenating products of the pose matrices with the vertices of the object to generate a concatenated product matrix.

30. The machine-readable storage medium of claim 29, wherein the calibrated projection matrix is computed by multiplying the concatenated screen coordinate matrix with an inverse of the concatenated product matrix.
